(19) United States
(12) Patent Application Publication
(10) Pub. No.: US 2019/0333171 A1
(43) Pub. Date: Oct. 31, 2019

(54) TRANSPORTATION EXCHANGE BASED ON BLOCKCHAIN TECHNOLOGY

(71) Applicant: Executive Jet Exchange, LLC, Fort Lauderdale, FL (US)

(72) Inventor: Tokhir Tokhtabaev, Lakewood Ranch, FL (US)

(21) Appl. No.: 16/296,666

(22) Filed: Mar. 8, 2019

Related U.S. Application Data
(60) Provisional application No. 62/663,533, filed on Apr. 27, 2018.

(51) Int. Cl. G06Q 50/14; G06Q 10/02; G06Q 30/06

(52) U.S. Cl. CPC G06Q 50/14; G06Q 30/0641; G06Q 30/0635; G06Q 10/02

(57) ABSTRACT

An exchange for brokers and operators for buying and selling transportation services based on Blockchain technology. A computer system maintains a database of available transportation services utilizing data provided by operators of the transportation services. Brokers access the computer system to search for and purchase transportation services that match customer needs.

### CROSS-REFERENCE TO RELATED APPLICATIONS

This application claims the benefit of U.S. provisional patent application Ser. No. 62/663,533 filed Apr. 27, 2018.

### FIELD OF THE INVENTION

This disclosure relates generally to an exchange for buying and selling private transportation services and, more particularly, to a method for brokers and operators to buy and sell transportation services using an exchange that is based on blockchain technology utilizing a centralized computer in communication with a communications network such as the Internet.

### BACKGROUND OF THE INVENTION

Current online services allow a user of the online service to view multiple options for travel plans and make a selection from among the multiple options. For example, an airline may operate a webpage that provides an online reservation service from which a user may search for available flights (e.g., from Miami to New York) on a particular day and then select one of the available flights for reserving a seat thereon. As another example, a hotel may operate a webpage that provides an online reservation service from which the user may search for available hotel properties and room types (e.g., in New York) for a particular period of time (e.g., March 4 through March 8) and then select one of the available room types at an available hotel property for reserving. As a further example, a restaurant may offer a webpage that provides an online reservation service from which the user may search for available table reservations within a particular range of times (e.g., 6:30 PM to 8:00 PM) on a particular date and then select one of the available table reservations for reserving.

However, in some instances the online services are not suitable for specialized and/or unscheduled requirements to transport people and/or goods. Brokers of transportation services often spend considerable time locating an appropriate operator for the services required by a customer, and commonly utilize an intermediary broker to eliminate the need for the customer to locate, purchase, and arrange for the transportation services. Herein “transportation services” include the use of private aircraft, trucks, cars, boats, railroad cars, drones, etc. to move people and/or goods from place to place.

For example, business jet brokers and operators that buy and sell private flights in the private jet industry are constantly working to find contacts, communicate changes and sign deals, which produces giant stacks of paperwork and makes the process, inefficient, costly and time consuming. If a customer uses a business jet broker in person or online, the broker contacts multiple operators based on the criteria of the customer's transportation requirement. In most cases, the operators don't own the jets, but manage jets for owners, meaning many times the operators have to get approval from the owner before confirming the quote. Each owner's contract with their management company is different, and each flight entails variable expenses from landing fees, which can vary by time of day, to FBO charges, parking fees if the jet is staying in one place, airport fees, and so forth. In some cases, the operator handles the pricing manually and then gives a quote back to the broker, who after assembling quotes for several airplanes from different operators, will send the quotes to the customer. Since many consumers call several brokers, this process expands multifold for each request. Calculating each quote can take 30 to 45 minutes. Even the companies invoking Uber are simply consumer facing apps, but there is still the same human activity on the back end where the operator has to put together the quote.

Blockchain is becoming a lower cost, more efficient way to share information and data between open and private business networks. Based on a distributed, peer-to-peer (P2P) topology, Blockchain or distributed ledger technology (DLT) allows data to be stored globally on thousands of servers—while letting anyone on the network see everyone else's entries in real-time. That makes it difficult for one user to gain control of, or game, the network. For businesses, Blockchain holds the promise of transactional transparency—the ability to create secure, real-time communication networks with partners around the globe to support everything from supply chains to payment networks to real estate deals and healthcare data sharing.

As each transaction occurs—and the parties agree to its details—it's encoded into a block of digital data and uniquely signed or identified. Each block is connected to the one before and after it—creating an irreversible, immutable chain. Blocks are chained together, preventing any block from being altered or a block being inserted between two existing blocks. Blockchain creates a shared system of record among business network members, eliminating the need to reconcile disparate ledgers. Each member of the network must have access privileges. Information is shared only on a need-to-know basis. Consensus is required from all members and all validated transactions are permanently recorded. Even a system administrator can't delete a transaction.

### BRIEF SUMMARY OF THE INVENTION

The following discussion discloses and describes an exchange for brokers and operators to buy and sell transportation services that is based on Blockchain technology, which simplifies international business transactions.

The invention involves a method for buying and selling transportation services on an exchange using blockchain technology comprising the steps of: providing networked computer system including a machine readable medium storing transportation services data representing available transportation services and a set of program instructions for operating the exchange, a memory, and a processor connected to the machine readable medium and the memory for executing the program instructions, the processor reading the transportation services data previously stored from and storing new transportation services data in the machine readable medium; enabling a first plurality of operators access to the computer system for inputting the transportation services data representing their available transportation services to be stored in the machine readable medium; enabling a second plurality of brokers access to the computer system for searching the stored transportation services data and purchasing a selected one of the available transportation services; and for each of the transportation services purchased, notifying a one of the operators and a one of the brokers associated with the purchase. The transportation services can be at least one of private aircraft flights, car trips, truck trips, railroad car trips, boat voyages and drone flights.

The method includes a step of registering with the exchange as one of the operators or one of the brokers by providing required identification information including a user name and a password to access the computer system.

The method includes a step of each of the operators submitting a predetermined deposit amount for each of their available transportation services input to the computer system and releasing a one of the deposit amounts associated with each of the transportation services purchased.

The method includes a step of enabling the brokers to resell the purchased transportation services through the computer system.

The method includes a step of recording all transactions associated with the transportation services processed through the computer system in a Blockchain and can further include a step of utilizing a smart contract to approve the transportation services purchased.

The method includes a step of operating the computer system to generate a home page screen on a communication device display to enable a user of the communication device to enter request information into the computer system for searching the stored transportation services data for any of the available transportation services matching the entered request information.

The method includes a step of operating the computer system to generate a buy/sell form screen on a communication device display to enable a user of the communication device to enter the new transportation services data.

The method includes a step of operating the computer system to generate a buy/sell form screen on a communication device display to enable a user of the communication device to enter the new transportation services data representing a previously purchased one of the available transportation services to be offered for resale.

The method includes a step of operating the computer system to generate a purchase screen showing on a communication device display the available transportation services matching request information input by the user. The purchase screen can show each of the matching available transportation services as a ticket. The purchase screen can respond to a “click” on one of the tickets selected by the user to signal the computer system that the user has purchased the available transportation service represented by the selected ticket.

The method includes a step of operating the computer system to generate a purchased screen showing on a communication device display the available transportation services previously purchased by the user of the communication device.

Additional features of the disclosure will become apparent from the following description and appended claims, taken in conjunction with the accompanying drawings.

### BRIEF DESCRIPTION OF THE DRAWINGS

FIG. 1 is a block diagram of a networked computer system for performing the method according to the invention;

FIG. 2 is an illustration of a home page of an exchange for buying and selling transportation services using the computer system of FIG. 1 as generated on a communication device display screen;

FIG. 3 is a flow chart diagram showing the method of buying and selling transportation services performed by the computer system of FIG. 1;

FIG. 4 is an illustration of a buy/sell screen generated by the computer system of FIG. 1 on a communication device display;

FIG. 5 is an illustration of a flight purchase screen generated by the computer system of FIG. 1 on a communication device display;

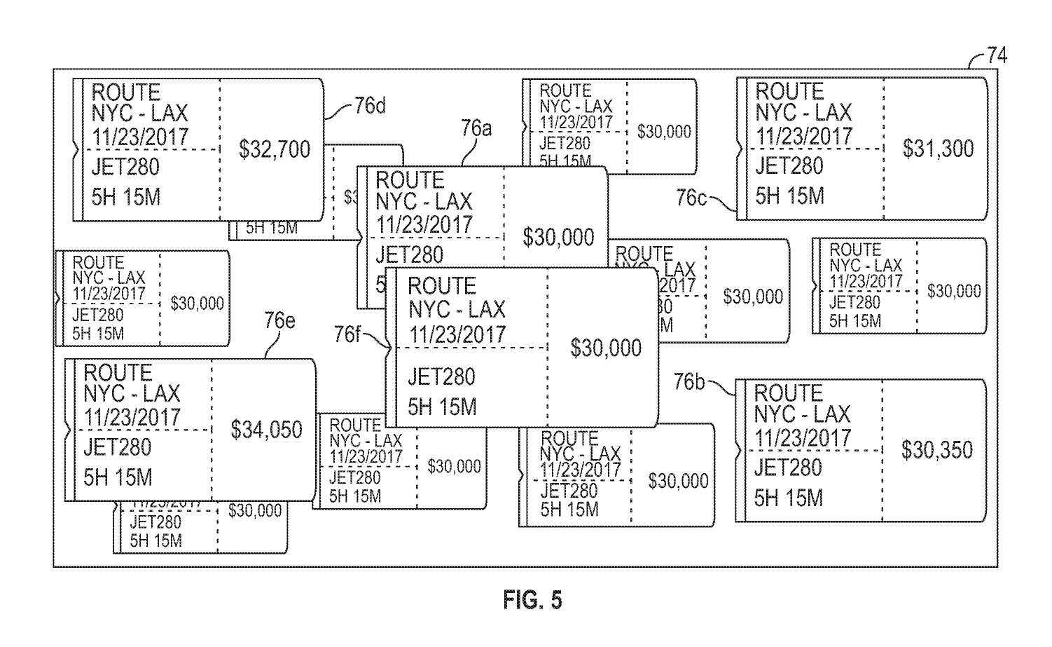

FIG. 6 is an illustration of a broker purchased flights screen generated by the computer system of FIG. 1 on a communication device display; and

FIG. 7 is a block diagram showing blocks in a Blockchain used to perform the method according to the invention.

### DETAILED DESCRIPTION OF THE INVENTION

The U.S. provisional patent application Ser. No. 62/663,533, filed Apr. 27, 2018, is incorporated herein by reference.

The following discussion of the embodiments of the disclosure directed to an exchange for brokers and operators to buy and sell transportation services that is based on Blockchain technology is merely exemplary in nature and is in no way intended to limit the invention or its applications or uses.

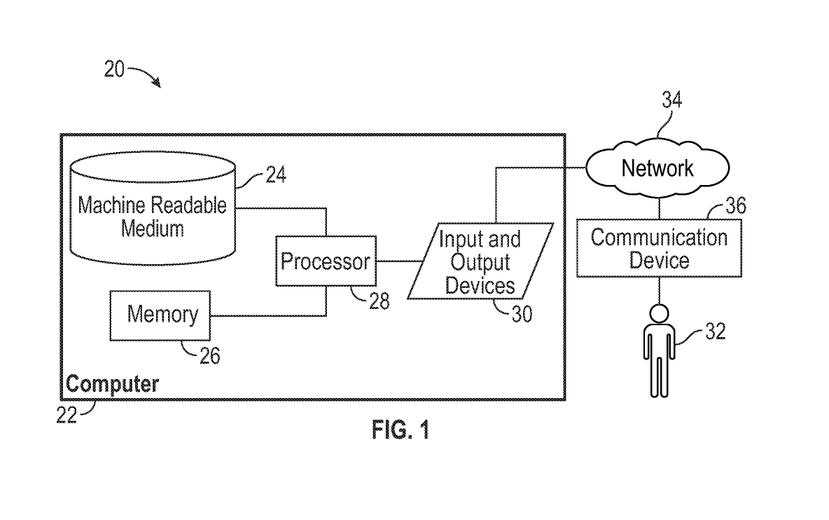

FIG. 1 illustrates a networked computer system 20 that can be configured into a special purpose computer to implement the system, method and exchange described herein. The system 20 includes a computer 22 having a machine readable medium 24, a memory 26, a processor 28, and input and output devices 30. The machine readable medium 24 could be a disk drive, thumb drive, CD, DVD or other device capable of being read by the processor 28. The machine readable medium 24 stores program instructions and data where the program instructions and data can be run on the processor 28 with the memory 26 to create the functionality described in this application. The computer 22, using the input and output devices 30, can communicate on the network 34 with a user 32.

The present disclosure describes an exchange that can be accessed by the user 32 through a website using a communication device 36 such as a laptop or a smartphone. For example, brokers and operators can buy and sell flights in the private jet industry through the exchange that is based on Blockchain technology, which simplifies international business aviation. Generally, the Blockchain is a model for the way information is shared using distributed ledger technology to save time and administration costs. More particularly, the Blockchain is a public electronic ledger that can be openly shared among disparate users and that creates an unchangeable record of their transactions. Each digital record or transaction in a thread is a block and it allows either an open or controlled set of users to participate in the electronic ledger, where each block is linked to a specific participant. Blockchain can only be updated by consensus between participants in the system, and when new data is entered it can never be erased. The exchange according to the invention allows aircraft operators to sell all of their flights in advance for fiat money or crypto-currencies.

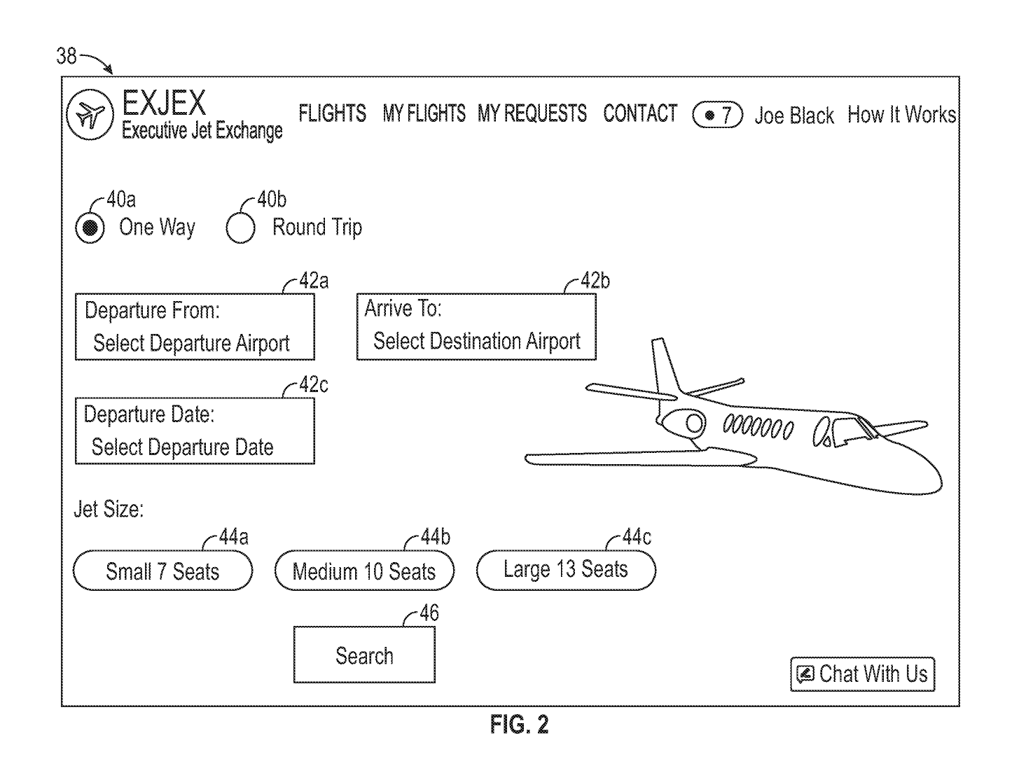

FIG. 2 shows the “Home” web page 38 generated by the computer system 20 and displayed on the screen of the user's communication device 36. Although business jet transportation services are used as an example, the following description applies to all types of transportation services. The user 32 is a broker who is a registered member of the exchange and desires to search for an available jet to satisfy a customer request. After logging in, typically with a user name and a password, several areas of the web page display 38 become active for making selections in order to search for available jets. A “one way” radio button 40a and a “Round trip” radio button 40b enable the broker to select the type of trip. When activated a first drop down box 42a displays a list of departure airports from which to select. When activated a second drop down box 42b displays a list of destination airports from which to select. When activated a third drop down box 42c displays a calendar from which to select a departure date. The next step is to select the size of jet desired by the customer. Provided are a “SMALL 7 SEATS” select button 44a, a “MEDIUM 10 SEATS” select button 44b, and a “LARGE 13 SEATS” select button 44c. The number of select buttons and the size designations shown are examples only and will depend upon the types of jets available from the operators that are members of the exchange. Now the broker is ready to search the exchange database of available flights by selecting the “SEARCH” button 46.

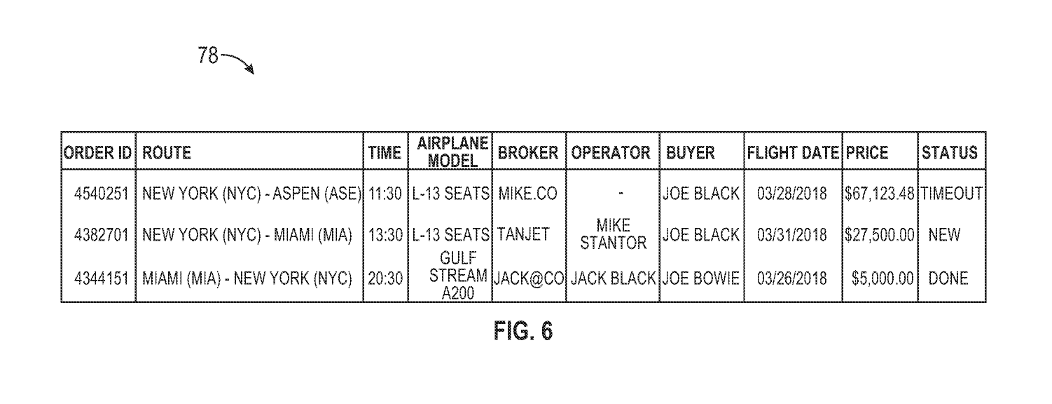

The exchange database of available flights can be stored in the machine readable medium 24 or any other suitable data storage device. The data in the exchange database is created in accordance with the method steps shown in the flow diagram 48 illustrated in FIG. 6. At a step 50 operators and brokers sign up (register) to be members of the exchange by providing the required identification information including user names and passwords to access the exchange. In a step 52, a registered operator enters data for an available flight such as type of aircraft, departure and destination airports, available dates and flight cost and then makes a deposit of 0.5% of the flight cost. The deposit is earned by the exchange when the associated flight is sold. At step 54, all of the exchange members are enabled to buy and resell the flights from and to respectively each of the other exchange members.

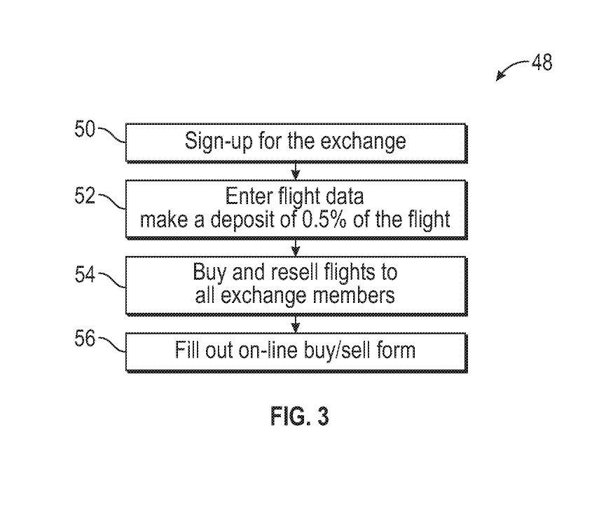

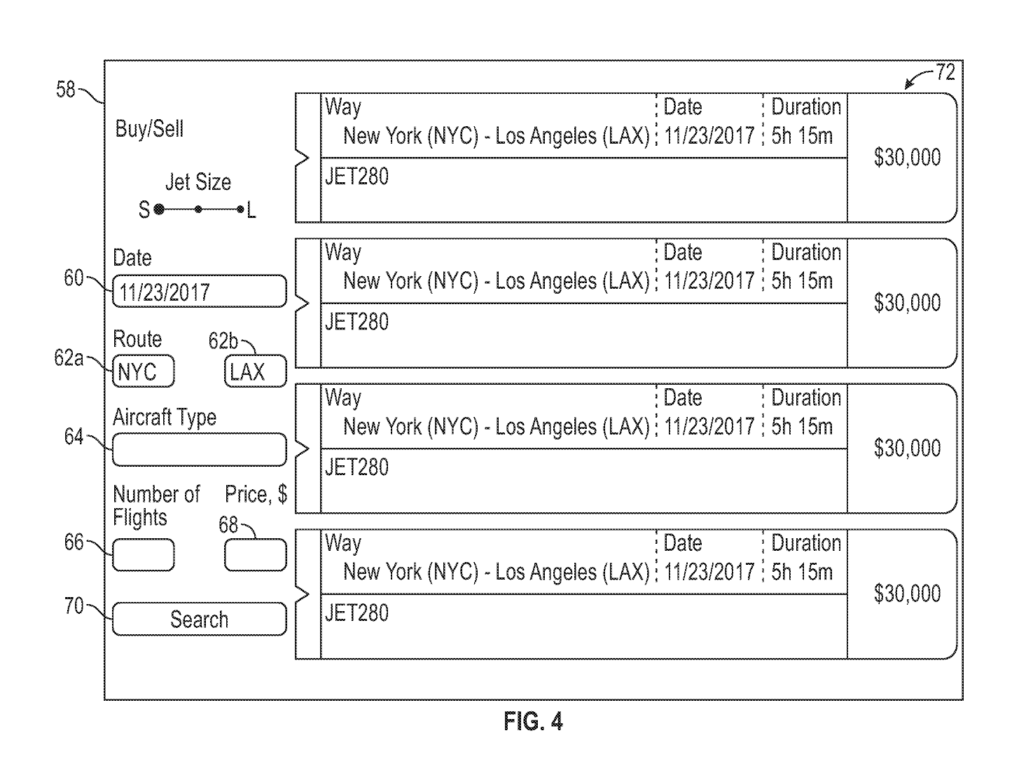

To offer a flight for sale, at step 56 in FIG. 3, an operator goes to an online buy/sell form screen 58, see FIG. 4, displayed on the screen of the user's communication device 36. The operator chooses the date of the flight in a box 60, sets the flight route in boxes 62a and 62b, enters the aircraft type in a box 64, enters the number of such flights available in a box 66, sets the price of the flight in a box 68 and clicks a sell button 70 to offer the flight(s). Each of the flights offered by that operator is shown in a flight information display area 72. A broker who has purchased a flight and desires to resell it uses the same buy/sell form.

The search initiated from the exchange screen 38 of FIG. 2 displays the search results on a flight purchase screen 74 on the user's communication device 36. For example, flights for the NYC-LAX route are shown with the date, the cost, the aircraft type and the flight time on individual “tickets”. In this example, the “tickets” 76a to 76e are shown with the only difference being the flight cost. When the broker clicks on one of the “tickets” 76a to buy the associated flight, an enlarged duplicate “ticket” 76f is displayed to identify the purchase. The associated operator and the purchasing broker will each receive a notification of the flight purchase from the exchange on their communication devices 36 or any other notification means they have designated. All of the member operators and brokers can view all of the flight information in the database. This promotes price competition to the benefit of the transportation services users. Operators can sell flights in advance while brokers have the opportunity resell flights they have purchased from the operator at a higher price to their clients. If an operator updates the information associated with a flight, the broker can manage his accounts using his communication device 36.

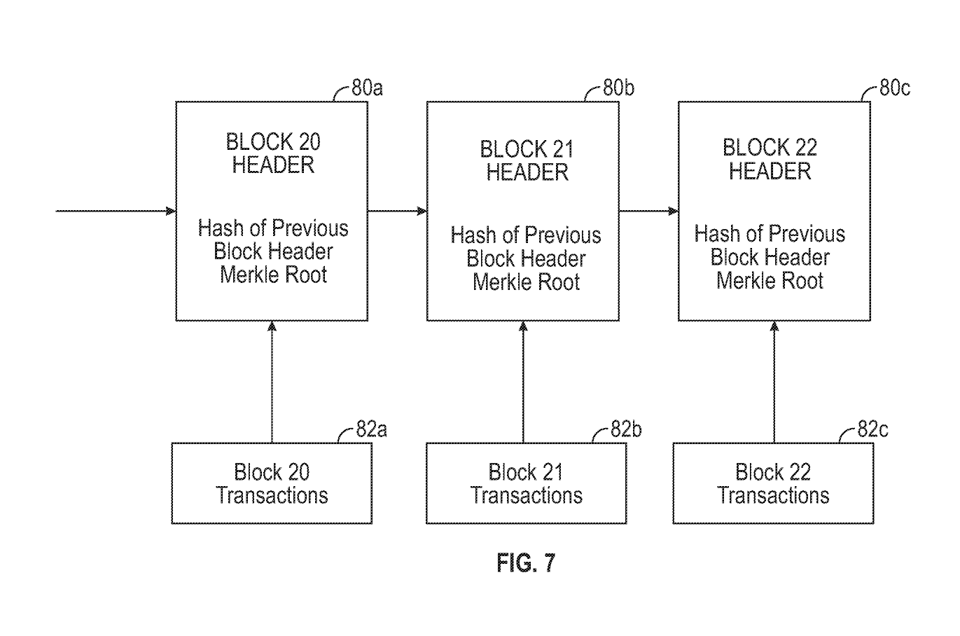

The transportation services transactions processed through the exchange apparatus and method can be recorded in a Blockchain to create an unchangeable record of the transactions. Blockchain can only be updated by consensus between participants in the system, and when new data is entered it can never be erased. The exchange according to the example of the invention described above allows aircraft operators to sell all of their flights in advance for fiat money or crypto-currencies. Shown in FIG. 7 are three blocks 80a, 80b and 80c representing three different flights offered on the exchange. Each of the blocks includes all of the transactions 82a, 82b and 82c associated with the respective flight. Each of the transactions is individually hashed to produce its corresponding hash value. Each of the hash values is combined with an adjacent hash value (e.g. “H₁” with “H₂”) and hashed again to the produce another hash (“H₁₂”). If there is an odd number of hash values, one hash is paired with itself and hashed (e.g., “H₃ and “H₃” produces “H₃₃”). The process is repeated until the last hash value is obtained, which value is known as the merkle root.

The Blockchain exchange network described above can be used for “smart contracts,” or scripts for business automation that execute when certain contractual conditions are met. A smart contract can be used to approve the sale of a flight. Once conditions are met between the operator, the broker and their financial institutions, the sale can be confirmed on the Blockchain.

As explained above, the apparatus and the method described for implementing the private aircraft flight services is an example of the invention. The apparatus and the method according to the invention can be used for any other transportation service such as car trips, truck trips, railroad car trips, boat voyages, drone flights, etc.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

1. A method for buying and selling transportation services on an exchange using blockchain technology comprising the steps of:
providing networked computer system including a machine readable medium storing transportation services data representing available transportation services and a set of program instructions for operating the exchange, a memory, and a processor connected to the machine readable medium and the memory for executing the program instructions, the processor reading the transportation services data previously stored from and storing new transportation services data in the machine readable medium;
enabling a first plurality of operators access to the computer system for inputting the transportation services data representing their available transportation services to be stored in the machine readable medium;
enabling a second plurality of brokers access to the computer system for searching the stored transportation services data and purchasing a selected one of the available transportation services; and
for each of the transportation services purchased, notifying a one of the operators and a one of the brokers associated with the purchase.

2. The method according to claim 1 wherein the transportation services are private aircraft flights.

3. The method according to claim 1 wherein the transportation services are at least one of private aircraft flights, car trips, truck trips, railroad car trips, boat voyages and drone flights.

4. The method according to claim 1 including a step of registering with the exchange as one of the operators or one of the brokers by providing required identification information including a user name and a password to access the computer system.

5. The method according to claim 1 including a step of each of the operators submitting a predetermined deposit amount for each of their available transportation services input to the computer system and releasing a one of the deposit amounts associated with each of the transportation services purchased.

6. The method according to claim 1 including a step of enabling the brokers to resell the purchased transportation services through the computer system.

7. The method according to claim 1 including a step of recording all transactions associated with the transportation services processed through the computer system in a Blockchain.

8. The method according to claim 7 including a step of utilizing a smart contract to approve the transportation services purchased.

9. The method according to claim 1 including a step of operating the computer system to generate a home page screen on a communication device display to enable a user of the communication device to enter request information into the computer system for searching the stored transportation services data for any of the available transportation services matching the entered request information.

10. The method according to claim 1 including a step of operating the computer system to generate a buy/sell form screen on a communication device display to enable a user of the communication device to enter the new transportation services data.

11. The method according to claim 1 including a step of operating the computer system to generate a buy/sell form screen on a communication device display to enable a user of the communication device to enter the new transportation services data representing a previously purchased one of the available transportation services to be offered for resale.

12. The method according to claim 1 including a step of operating the computer system to generate a purchase screen showing on a communication device display the available transportation services matching request information input by the user.

13. The method according to claim 12 wherein the purchase screen shows each of the matching available transportation services as a ticket.

14. The method according to claim 13 wherein the purchase screen responds to a “click” on one of the tickets selected by the user to signal the computer system that the user has purchased the available transportation service represented by the selected ticket.

15. The method according to claim 1 including a step of operating the computer system to generate a purchased screen showing on a communication device display the available transportation services previously purchased by the user of the communication device.

16. A method for buying and selling flight services on an exchange using blockchain technology comprising the steps of:
providing networked computer system including a machine readable medium storing flight services data representing available flight services and a set of program instructions for operating the exchange, a memory, and a processor connected to the machine readable medium and the memory for executing the program instructions, the processor reading the flight services data previously stored from and storing new flight services data in the machine readable medium;
enabling a first plurality of operators access to the computer system for inputting the flight services data representing their available flight services to be stored in the machine readable medium;
enabling a second plurality of brokers access to the computer system for searching the stored flight services data and purchasing a selected one of the available flight services; and
for each of the flight services purchased, notifying a one of the operators and a one of the brokers associated with the purchase.

17. The method according to claim 16 wherein the flight services are at least one of private aircraft flights and drone flights.

18. The method according to claim 16 including a step of recording all transactions associated with the flight services processed through the computer system in a Blockchain.

19. The method according to claim 18 including a step of utilizing a smart contract to approve the flight services purchased.

20. The method according to claim 16 including a step of operating the computer system to generate a purchase screen showing on a communication device display the available flight services matching request information input by the user and wherein the purchase screen shows each of the matching available flight services as a ticket.
